(19) United States
(12) Patent Application Publication
(10) Pub. No.: US 2008/0025255 A1
(43) Pub. Date: Jan. 31, 2008

(54) Multiple traffic types in a multicarrier system

(76) Inventors: Deepshikha Garg, Mountain View, CA (US); Radhakrishna Canchi, Cupertino, CA (US)

Correspondence Address: KYOCERA WIRELESS CORP., P.O. BOX 928289, SAN DIEGO, CA, 92192-8289, US

(21) Appl. No.: 11/492,566

(22) Filed: Jul. 25, 2006

(51) Int. Cl. H04Q 7/00

(52) U.S. Cl. 370/329; 370/338

(57) ABSTRACT

Disclosed is a wireless communications system having multiple communication channel types in a multi-carrier system. The different channel types, which correspond to different data rates, are allocated depending on the type of session being initialized (its data rate requirements). This is accomplished using different orthogonal code lengths with different carriers and their subcarriers. An orthogonal code length is assigned to a carrier and used with its subcarriers to create a set of assignable channels having differing data rates. The association between a carrier and an orthogonal code length can be dynamically reassigned depending on the needs of active sessions.

### FIELD OF THE INVENTION

The present invention relates to the field of wireless communication devices. More specifically the invention relates to the creation and use of unique channels in a multicarrier system, enabling efficient allocation of multiple traffic types.

### BACKGROUND OF THE INVENTION

Wireless technologies are classed into generations. First generation wireless communications systems, or 1G systems, were introduced in the late 1970s or early 1980s (1983 in the US) and were entirely analog circuit-switched systems. AMPS and TACS are examples of 1G systems. 2G systems include GSM and IS-95A. 2G systems are no longer entirely analog, but are still designed as circuit-switched systems. Some 2G systems provide some support for packet-switched data, and can achieve data transfer rates in the range of 14.4 to 28.8 Kbps. In addition to voice traffic, 2G systems typically enable some usage of capabilities such as SMS text messaging. However, they are too slow for any activities such as web surfing, picture viewing, or other data-intensive applications. 3G systems include UMTS and CDMA2000. 3G systems are enabled for both circuit-switched voice and packet-switched data, and can achieve data rates ranging from 384 Kbps to 2 Mbps. Eventually the goal is to provide 4G systems with data rates significantly greater than 3G systems.

Due to the lead-time and expense of upgrading wireless infrastructures, many service providers have implemented 2.5G systems. 2.5G systems are intended to bridge the gap between 2G systems and 3G systems; 2.5G systems include GPRS and IS-95B. 2.5G systems are characterized by their ability to better handle digital data as compared to 2G systems by adding additional support for packet-switched data. In addition, 2.5G systems generally require less capital expenditure on the part of the service providers as compared to 3G equipment, and are compatible with a larger amount of legacy wireless devices now in the field.

In addition to the cellular mobile systems described above, Wireless LAN (WLAN) systems have been evolving since the late 1980s and early 1990s. WLANs are packet-switched networks by design, and do not support circuit-switching. This is good for data transmission, but made them incompatible with circuit-switched telephone systems. The early WLANs had relatively slow data rates and extremely limited mobility capabilities. Data rates increased over time with the advent of IEEE 802.11a/b/g compliant systems. More recently, wireless data systems are starting to take mobility into account with IEEE 802.16e and 802.20 systems.

Telephone or voice-based systems tend to be poorer at efficiently handling multiple simultaneous users having widely varying data rate needs, while the WLAN connections are poorer at efficiently handling mobile voice connections. As use of both types of systems has increased, there is increasing demand and need for systems that can combine the better resource usage characteristics of each of the older systems.

### SUMMARY

The disclosed inventive concepts are based on a multicarrier system having unique set of communications channels. The system has a set of carriers, generally indicated by N. Each carrier has a set of M orthogonal subcarriers. Also available are orthogonal spreading code sets, each set having a different length being an integer less than or equal to M. The communications channels are configurable for different data rates by combining various logical orthogonal code lengths with different carriers and subcarriers. The number of assignable channels in each carrier is the same as the code length associated with that carrier, which also determines its data rate.

A channel is selected for a session by gathering available information on the channel type as the session is being started or initiated. A session will usually be initialized as part of a service initiation request generated by one end-node or party. The service initiation request will often contain the type of session being requested. A channel supporting the data rate required for the session will be assigned. Types of channels can be determined based on the type of transfer or service requested, such as an http request, an ftp request, a voice-only request, a streaming audio and/or video channel, etc. The system can reasonably assess the data rate needed to optimally service the request.

Once a data rate assessment is made, the system can assign a channel to the session. The channel will have a data rate reflective of an initial assessment of the needed data rate, or may use a default assignment if an assessment can not be made. The presently disclosed system supports multiple channels of different data rates (also called channel types). A symbol to be transmitted over a selected channel type will be spread using a spreading code of length L, and will then be transmitted using a carrier associated with the same length L. Each carrier will have M subcarriers, and each carrier will also have L logical channels which make use of the M subcarriers. Likewise, the system receiving these transmissions will be configured with the orthogonal spreading code of length L, and will know which carrier the session is assigned to. It uses that information to retrieve the symbols from the designated set of subcarriers on a carrier. The association between the logical spreading codes and the subcarriers in a carrier is explained more fully below.

The disclosed system is also unique in its ability to adapt to changing data rate needs in a single session, and to adapt to the needs of the current population of users (active sessions). The system can hand off a session between channels to optimize the usage of the channels in use. This may be from a slow data rate channel to a high one, and then back to a low data rate channel again. The system can monitor the channel traffic and determine which channels are underutilized. Sessions on an underutilized channel can be handed off to a lower data rate channel. The system can also reconfigure itself to add higher data-rate channels by reducing the number of lower data-rate channels, or can increase the number of lower data-rate channels by reducing the number of high data-rate channels.

The presently disclosed system can reconfigure its selection of channels if the session loads make that desirable for efficient usage of the available bandwidth (overall frequency range). If there is a set of channels at a certain data rate that are underutilized, the system can reconfigure itself by quiescing the underutilized carrier or carriers, then will reassign a different code length L to that carrier. If the new code length is shorter than the previous code length, the result will be fewer, high data-rate channels. If the new code length is longer than the previous code length, the result will be more assignable channels, but each will be slower than the previous channels. This allows the system to dynamically optimize itself.

Other features and advantages of the presently disclosed inventive concepts will become readily apparent after reviewing the following detailed description and accompanying drawings.

### BRIEF DESCRIPTION OF THE DRAWINGS

FIG. 1 is an illustration showing bandwidth use according to TDMA, FDMA, CDMA, and OFDM.

FIG. 2 illustrates bandwidth use in accordance with the presently disclosed inventive concepts.

FIG. 3 illustrates exemplar channel sets in accordance with the presently disclosed inventive concepts.

FIG. 4 is a block diagram of a transmitter and receiver in accordance with the presently disclosed inventive concepts.

FIG. 5 is a high-level diagram of a wireless network in accordance with the presently disclosed inventive concepts.

FIG. 6 is a flow diagram using a multi-channel multicarrier system in accordance with the presently disclosed inventive concepts.

### DETAILED DESCRIPTION

Persons of ordinary skill in the art will realize that the following description of the present invention is exemplary and not limiting. Other embodiments of the invention will readily suggest themselves to such skilled persons who also have the benefit of the present disclosure.

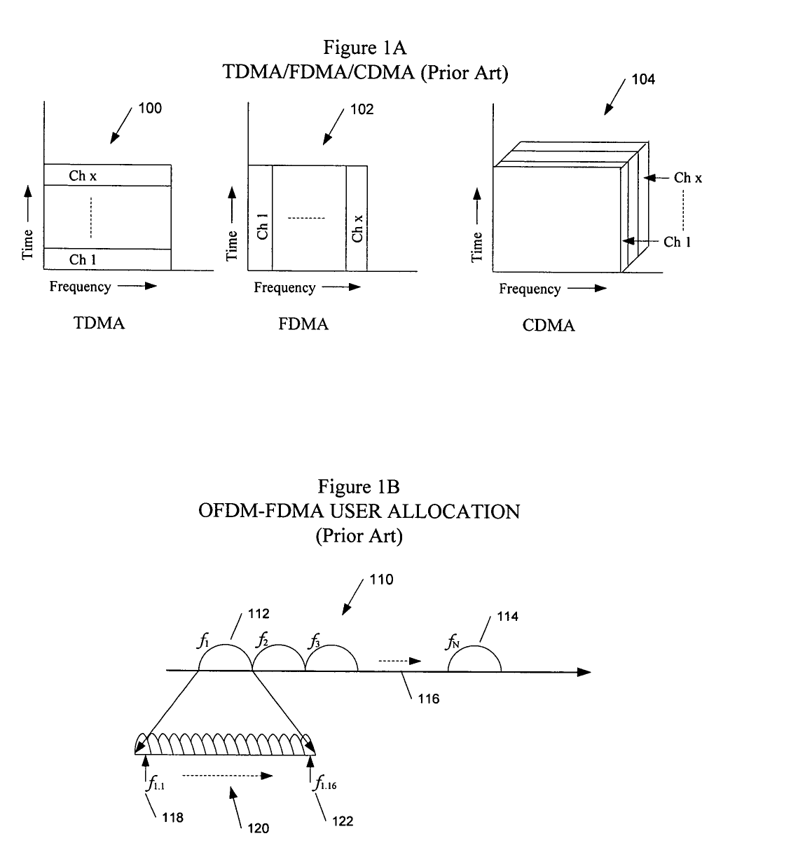

Referring generally to the drawings, for illustrative purposes the present invention is shown embodied in FIG. 1 through FIG. 6. It will be appreciated that the apparatus may vary as to configuration and as to details of the parts, and that the method may vary as to details and the order of any acts, without departing from the inventive concepts disclosed herein.

The word “exemplary” is used to mean “serving as an example, instance, or illustration.” An embodiment described as “exemplary” is not necessarily to be construed as preferred or advantageous over other embodiments.

Referring first to FIG. 1A, illustrated are three ways of allocating bandwidth. Graph 100 shows time division multiple access (TDMA) based bandwidth allocation, where multiple users are multiplexed by allocating each a different time slot. Time slots are used to make up a channel, which cannot be shared (is assigned to a single user). Shown are channels Ch 1 through Ch x. Graph 102 illustrates frequency division multiple access (FDMA), which allocates a portion of the available frequency band to a user, called a subfrequency. Each subfrequency is usable only by a single user, and is illustrated by channels Ch 1 through Ch x. Graph 104 illustrates code division multiple access (CDMA), which uses logical codes to separate users. In a CDMA system all of the users use the same frequency range; the different signals are separated using orthogonal spreading codes. Each code is used to create a channel, assigned to a single user. Illustrated are channels Ch 1 through Ch x, where each channel uses a different orthogonal spreading code.

Additional details on existing TDMA, FDMA, and CDMA systems can be found in many text books, one being “Mobile Wireless Communications” by Schwartz, ISBN 13-9780521843478, which is hereby explicitly incorporated in full into this application.

Referring to FIG. 1B, illustrated is an Orthogonal Frequency Division Multiplexing, OFDM-FDMA system 110. Overall frequency range 116 has frequency bands or carriers f₁ (112) through f_{N} (114). Each of these carriers is further divided into a set of subcarriers 120, illustrated as f_{1.1} (118) through f_{1.16} (122). This is for illustrative purposes; the actual number of subcarriers may vary. Each of these subcarriers is orthogonal to the other subcarriers, allowing their bandwidths to overlap with minimal interference (illustrated as overlapping curves). Additional details of OFDM-related communications systems may be found in “OFDM and MC-CDMA for Broadband Multi-User Communications, WLANs and Broadcasting” by L. Hanzo et al., ISBN 0-470-85879-6, hereby explicitly incorporated in full into this application.

The word “channel” is used in differing ways in the literature, especially when comparing older and newer papers and texts. For example, until the 1980s an FDMA carrier and an FDMA channel were most often implemented as the same thing, and many writings used the terms interchangeably. As more complexity was added to carriers, the concepts have become increasingly differentiable. For the purposes of this disclosure, the term “channel” means any singly identifiable communications channel usable on or by wireless equipment, however that communications channel is configurable and derivable from both its underlying transport mechanisms and its logical construction from the (usually digital) information carried on the transport mechanisms. A communications channel enables source-to-destination or point-to-point communication. In the general case, there is no restriction on the type of information (data or voice) that may or may not be carried by any particular communications channel. Pragmatically the effective data-rate of a communications channel will at least partially, if not fully, determine what type of information it will carry.

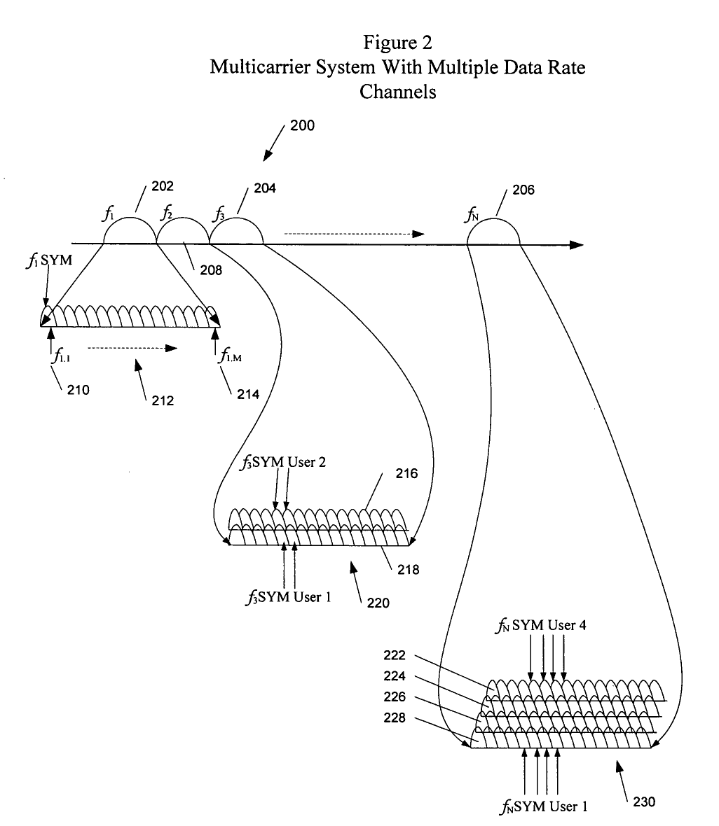

FIG. 2 illustrates channel generation and usage in accordance with the inventive principles disclosed herein. A multicarrier system using frequency range 200 (W) is divided into carriers 1 through N, each carrier having bandwidth or frequency range W/N. Illustrated in FIG. 2 are carriers 1 (202), 2 (208), 3 (204) and N(206). Each carrier is divided into a set of orthogonal subcarriers 1 through M, exemplified in FIG. 2 as M=16; in this example there will be subcarriers 1 through 16 for each carrier.

Each data symbol to be transmitted is multiplied by an orthogonal code of length L, where L is less than or equal to M (L<=M). Any kind of orthogonal code may be used (i.e., Walsh Hadamard, Gold, etc.). Each carrier is assigned a code length L, and the number of users that may be assigned to that carrier is also L. In FIG. 2 carrier f₃ 204 has code length L of 2, and may be assigned 2 users. This is illustrated for carrier 204, which has two logical channels 216 and 218. As with carrier 202, carrier 204 has M subcarriers. Unlike carrier 202, carrier 204 uses two logical orthogonal spreading codes, such as Walsh codes, when transmitting over its subcarriers. This creates 2 logical channels, one corresponding to each of the logical spreading codes. 216 and 218 are each a communications channel assignable to a different user.

Each data symbol is assigned L subcarriers, and an OFDM symbol carries an integer (M/L) number of such data symbols of each session of a user. An exemplar is a symbol being sent to user A, user A having been assigned as user 1 (logical channel 218) in carrier 204 where L=2. Since L=2 each symbol will be sent over 2 subcarriers. In this case, user A's symbol will be sent using the two subcarriers labeled as “f₃ SYM User 1” as part of A's usage of logical channel 218, which carries user A information over the air. Likewise, a symbol being sent to user B, user B having been assigned as user 2 (logical channel 216) in carrier 204, may be sent using the two subcarriers labeled as “f₃ SYM User 2”. Note that the two symbols are being sent over the same subcarriers; they are logically separated through the use of two orthogonal spreading codes. Each user will be sending 8 symbols using 16 subcarriers in parallel, the two users' signals each being spread using a different orthogonal code of length 2.

Carrier 206 has code length L of 4 (L=4). There can be 4 users assigned to use carrier 206, and each will use an orthogonal code of length 4. This results in 4 communications channels labeled as communications channels 222, 224, 226 and 228. Each communications channel will use 4 subcarriers for transmitting each symbol. Two exemplar symbol-to-subcarrier assignments are illustrated as “f_{N} SYM User 1” for user 1 on logical channel 228, and “f_{N} SYM User 4” for user 4 on logical channel 222. Note that each of the two exemplar symbols are being transmitted using the same subcarriers; they are logically separated through the use of different orthogonal spreading codes.

The case where L=1 is shown applied to carrier 202. Subcarrier set 212 is assigned to a single user, and no orthogonal coding is used on the symbols. It is not needed, as the entire carrier 202 and therefore all the subcarriers 212 carry the data of a single user when L=1. The assigned user's symbols are each sent on a single subcarrier, from f_{1.1} (210) to f_{1.M} (214). This is OFDM, and is the highest data-rate communications channel.

L=1 is one extreme case; the other extreme case is where L=M (not illustrated). If that configuration is used, each of the user's symbols will be spread using a spreading code of length L=M (in FIG. 2, this corresponds to L=M=16), and each symbol will be sent using all M subcarriers. Each subcarrier can carry the data of M users, each user having his own orthogonal code. This would be the slowest communications channel, being 1/M the speed of the channel associated with carrier 202, where L=1.

Generally, the fastest communications channel is when L=1. For communications channels using an orthogonal code spreading value L for 1<L<=M (for allowable values of L, typically powers of 2 but will also depend on how each system is configured), the resulting data rate on that channel will be slower by a factor of 1/L as compared to the fastest communications channel (the L=1 channel).

As will be clear to a person having skill in the performance/benchmarking art for wireless communications and who also has the benefit of the present disclosure, discussions of the relative speeds of channels and number of assignable channels, and similar concepts, may differ from the actual numbers observed in the field. For example, actual relative channel speeds and the number of channels assignable at a given time will also depend on the radio link conditions, the radio link parameters in use, as well as other variables. These variations are fully contemplated herein.

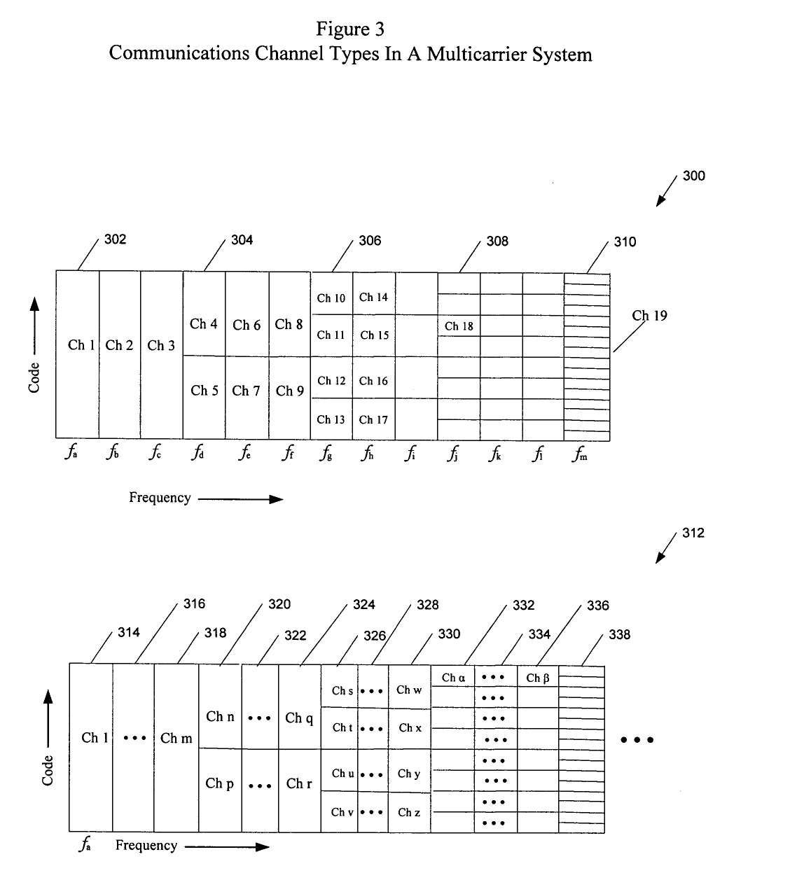

FIG. 3 is an exemplar layout of channels using the presently disclosed system. Channel layout 300 shows frequency ranges fₐ through fₘ along the horizontal axis. Orthogonal code usage is represented within each frequency range on the vertical axis. The first three frequency ranges (fₐ_{^{—}}f_{c}), exemplified by frequency range 302, are not subdivided into multiple channels, and use no orthogonal coding. These frequency ranges will each be used as a single communications channel, for high data rate applications or sessions. The next three frequency ranges (f_{d}_{^{—}}f_{f}), exemplified by 304, will be using two orthogonal codes concurrently per frequency range. This enables or creates two channels per frequency range. For the three frequency ranges shown, that yields 6 channels. Each of these 6 channels will support proportionately lower data rates than the first three channels (1/L, or ½). The next three frequency ranges (f_{g}_{^{—}}fᵢ) will each concurrently use one of four different orthogonal codes, yielding 12 assignable channels. The following three frequency ranges (fⱼ_{^{—}}fₗ) will each concurrently use one of 8 different orthogonal codes, yielding 24 channels. Finally, fₘ 310 is divided into 16 channels, each using a different orthogonal spreading code of length 16.

The total number of channels available in layout 300 is 46 having 5 different data rates. This compares to only 13 using OFDM. The 5 different data rates are usable for different traffic types. Voice-only or low data rate traffic can be assigned a channel from frequency band 310. The heaviest data traffic (needing the highest data rate) can be assigned to one of the first three channels, such as channel 302. Calls or communications sessions having intermediate data rate requirements will be assigned intermediate channels. This allows the system to support data-rate sessions from the highest down to the lowest for a given amount of bandwidth, in this case the overall frequency range of all the channels. In the exemplar system of FIG. 2, the overall frequency range spans the low end of frequency range f₁ to the high end of frequency range f_{N}.

The number of carriers will be known when the system is configured, as will the number of subcarriers available in the carriers. However, as load requirements in the operating (running) system change, the presently disclosed system can dynamically react. The changes needed will be based on the system's knowledge or detection of both the number and the types of sessions it is servicing. Based on current needs, the system can change L for any carrier (once the channels in the carrier are quiesced). For example, if the system detects that there are numerous low data rate calls (e.g., voice only) coupled with a growing number of very high data rate calls then system 300 can reconfigure the 6 L=2 channels (carriers f_{d} to f_{f}) into 3 L=1 channels for a system total of 6 very high data rate channels, and can reconfigure the 24 L=8 channels (carriers fⱼ to fₗ) into L=16 channels, yielding a system total of the 64 (48+16) low data rate channels. Any of the 64 low data rate channels can now be assigned to voice-only calls (low data rate sessions). Reconfiguration based on the orthogonal code length doubled the number of high data rate channels while simultaneously increasing the number of low data rate channels by 24 (from 24 medium data rate channels to 48 low data rate channels, for a total of 64 for the system illustrated). Also, if a user demands very high data rate and there is no L=1 channel available, the user (session) can be given 2 L=2 channels in 2 carriers, i.e., multiple channels can be assigned for the same session. For example in FIG. 3, channels 4 and 6 may be assigned to a user when channel 5, 7, 1, 2, and 3 are already assigned.

Generally, the system disclosed herein can be configured with differing numbers of different data rate channels as described above. Different data rates correspond to different channel types, where a channel type may be based on usage such as voice-only, web browsing, on-line interactive session, gaming, data downloading (i.e., pictures), etc. Channels types are characterized according to the data rates they are expected to use, from slowest to fastest. Each channel type will be usable to effectively carry certain kinds of data. Although in most cases a channel will be assigned to a session or call from beginning to end, the presently disclosed system may also make dynamic allocation of channels during a session or call, or may assign a channel for a specific action. For example a voice caller may start a picture download during a call, so needs the use of a high data rate channel for the download; otherwise the caller can make use of a low data rate channel. The system can assign a high data rate channel just for the download.

A general system configuration is shown as system 312. The frequency ranges are shown along the horizontal axis, and the number of logical channels, separated using orthogonal spreading codes, are shown along the vertical axis. Channels 314 and 318 represent channels which do not use orthogonal codes. Channel 316 represents any number of the same channel configurations as correspond to channels 314 and 318. Frequency ranges 320 and 324 represent the simultaneous use of two orthogonal spreading codes per carrier (L=2), enabling two channels per carrier; two channels for 320 and two channels for 324. 322 represents any number of the same channel types as found in frequency ranges 320 and 324. Each channel in 320, 322, and 324 will have approximately ½ the capacity as channels 314, 316, and 318. Frequency ranges 326 and 330 correspond to L=4 (spreading code of length 4), where each frequency range can support up to 4 channels. 328 represents any number of the same channels types found in 326 and 330. Frequency ranges 332 and 336 correspond to L=8 (spreading codes of length 8), and each may support 8 channels. 334 represents any number of the same channels types as a designer designs into a system in accordance with this disclosure. Finally, frequency range 338 corresponds to L=16, creating 16 channels per carrier set 338. Each channel in 338 will have approximately 1/16 the data carrying capability of channels 314, 316, and 318. The ellipses represent this pattern continues until the system being designed uses up the available allocatable frequency ranges.

For illustrative purposes the number of subcarriers (M) is shown as 16. A larger M with correspondingly larger L is too complex to effectively illustrate, but all configurations of M and L are fully contemplated as within the presently disclosed inventive concepts.

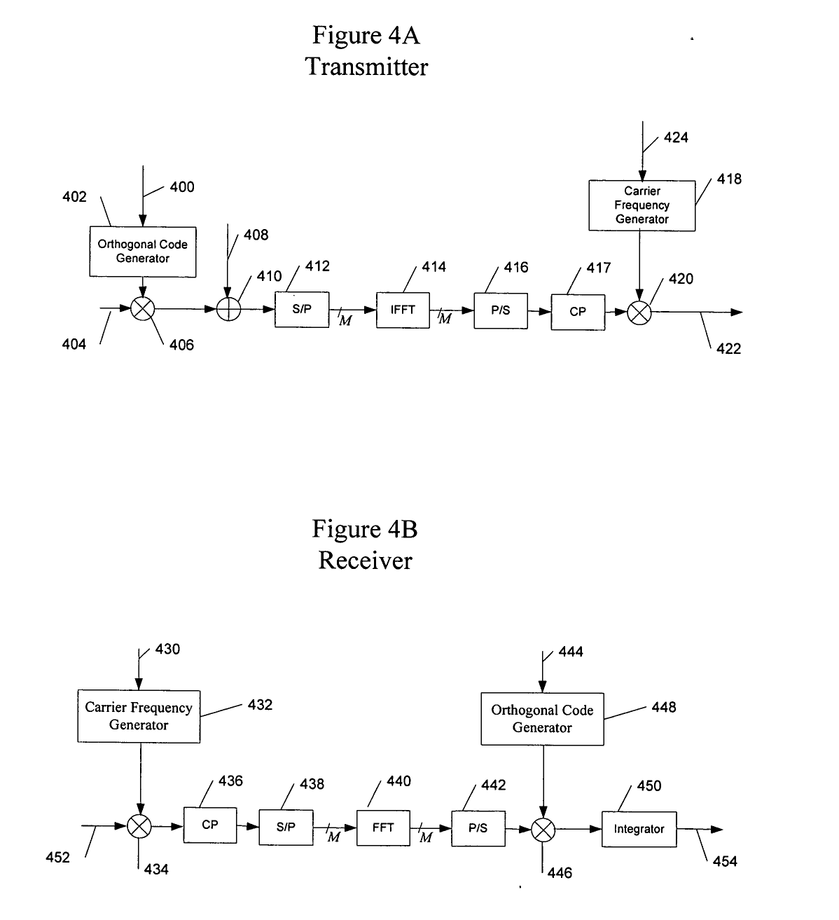

Referring to FIG. 4, shown is a block diagram of an exemplary transmitter in accordance with the disclosed inventive concepts. Input signal or input stream 404 comprises a modulated symbol sequence. This is multiplied by the orthogonal code generated by 402 at the multiplier 406. The orthogonal code in 402 is generated with input derived from the channel type a session needs (400). This will usually be based on the requested service or data transfer type, such as voice, ftp, http, etc., which in turn corresponds to a desired data rate. This information, indicated as input 400, is used to select an orthogonal code length (L) and is also used to select a frequency (input 424). The result of using input 400 in box 402 is the generation of an orthogonal code of the selected length, the code is then multiplied with the modulated signal (symbol sequence) resulting a spread symbol sequence.

Output from that operation may have data from other users 408 added at adder 410. When L>=2, the other users' data are multiplied by other orthogonal codes of the same length, resulting in the other user data 408. The resultant signal is then run through serial-to-parallel converter 412 and then into box 414 which corresponds to performing an Inverse Fast Fourier Transformation (IFFT). The “/M” symbol indicates M parallel lines. The output of IFFT box 414 is converted to a single stream by parallel-to-serial converter 416, and any needed cyclic prefix is added to the signal in CP box 417. The resulting signal is multiplied at multiplier 420 with the signal from 418. Box 418 feeds a carrier signal into multiplier 420, which was selected using input 424 as described above. The resultant OFDM signal 422 is ready to be sent to an amplification/antenna circuit for transmission.

A receiver is shown in FIG. 4B. The session's selected data rate information is known, as generated for the transmitter described above. The data rate information, which results in a selection of an orthogonal code of length L and a carrier frequency, is shown as inputs 430 and 444 respectively. Incoming signal 452 is an OFDM signal. It is multiplied by the correct carrier frequency, generated by carrier frequency generator 432, at multiplier 434. Cyclic prefix removal is carried out in CP box 436. The resultant signal is separated into M parallel signals at serial-to-parallel converter 438, and fed to FFT (Fast Fourier Transformer) 440. The resultant signal is then converted to a single stream in parallel-to-serial converter 442, and the single signal is multiplied in multiplier 446 with the output of Orthogonal Code Generator 448. The resultant signal is fed to Integrator 450, which combines the previously separated portions of individual symbols into a single symbol stream. The output signal 454 is ready to be demodulated.

Transmitter 4A and receiver 4B are exemplar embodiments of a transmitter and receiver usable in wireless components with the presently disclosed inventive concepts. The components in which these may be used will depend on where the presently disclosed wireless transmission system is used. One expected embodiment will locate the transmitter/receiver (tx/rx) in a mobile wireless device, including but not limited to a cell phone, PDA, portable computer, etc. Another tx/rx pair would be located in the base stations that support the mobile wireless communications devices. Other embodiments may use the disclosed system as a link between two non-terminal devices, resulting in a tx/rx being in two communicating wireless link stations. Other uses and embodiments will come to the mind of a person who has the advantage of the presently disclosed inventive concepts and who is also skilled in the wireless communications arts, all such embodiments being contemplated herein.

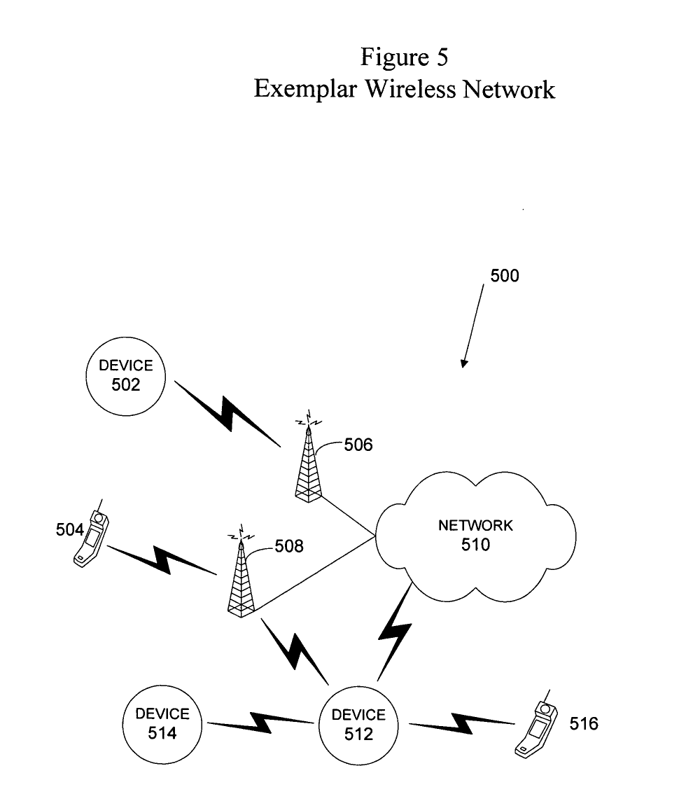

FIG. 5 is a high level block diagram illustrating an example wireless communication network 500 usable with the presently disclosed inventive concepts. The exemplar wireless communications network 500 comprises a plurality of end-point wireless devices 502, 504, 514 and 516, as well as non-end-point device 512. The devices may be any device having the wireless communications capacities described herein. 504 and 516 are shown as cell phones; however, they are non-limiting exemplar devices. Wireless communication network 500 additionally comprises a plurality of base stations 506 and 508 that are in operable communication with network 510. Base station 506 is in communications with device 502, and base station 508 is in direct communication with devices 504 and 512; it is also in indirect communication with devices 514 and 516. The base stations will typically be in communication with network 510. Network cloud 510 is intended to cover any wireless communications interface and system, including the embodiment where Base Stations interface to a switching node, into an IP Gateway, to a PSTN (public switched telephony network, or the landline network) etc., all embodiments of which are included in network cloud 510.

Wireless device 512 is in communication with one or more base stations, connected into network 510, using the wireless communications system described herein. Device 512, being a link between network 510 and devices 514 and 516, may be considered as part of network 500. Device 512 may be a standalone link and may also perform the functions of an end-point device. If device 512 is a general purpose computer, it may act as both an end-point device and as an active link to other devices, including end-point devices 514 and 516. Device 512 may also be a dedicated device, usable as a link but not intended to be an end-point device. Each device will include at least one instance of the tx/rx logic described above in FIG. 4, as needed for its function.

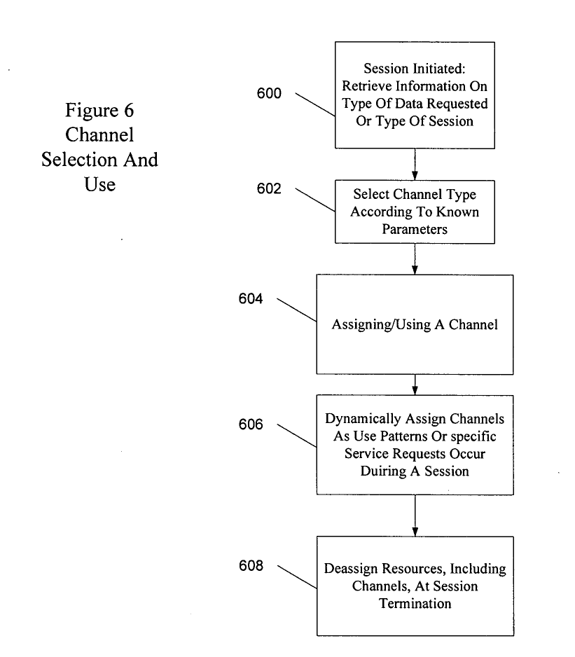

FIG. 6 is a flow chart showing use of a system in accordance with the present invention. The actions corresponding to box 600 are those carried out when a session is initiated. As used in this disclosure, a session may correspond to a user call, but a session is not limited to that one meaning. A session includes any communications link between any two devices over an air interface. For example, a session may be set up for the purpose of transferring the data that constitutes a picture or other single data transfer event. This may be a parallel session, where parallel means an additional session or channel between two locations that already have one active session, or may be a standalone session for the data transfer event. Further note that a session may be between two nodes on a network where the nodes are not end-point nodes.

Continuing with box 600, part of the session creation activities includes, on the device originating the session, detecting the type of session needed. The type of a session includes consideration of the type of connection being set up (voice, http, ftp, etc.), the amount of data to be transferred if known, as well as other factors such as the session's importance relative to other traffic. Continuing into box 602, the actions taken in this box include using the data from box 600 to determine the type of channel to request. In making this determination, the parameters of the system will be considered (i.e., the number of what types of channels that are currently assignable, etc.). Two primary pieces of information to be determined in box 602 are a code length (L) and a carrier frequency to use, which determine the channel.

Continuing into box 604, the actions corresponding to this box are those associated with using the selected orthogonal code length L and the selected carrier frequency. This information is provided to the transmitter and/or receiver via the control channel associated with an active session. The specifics on what is stored where and how for active session will vary widely, depending on the device. For example, if the device is a simple cell phone, then the state of the logic in the cell phone can be set for a single set of parameters for the duration of the session. If the device is more complex, especially if it is a base station or other non-end-point device, then it will make use of more complex ways of storing and using the settings or state associated with a plurality of active sessions. Taking into the account the wide variance in the devices usable with the presently disclosed inventive concepts, a channel data (orthogonal code, carrier frequency) is provided to and used by the transmitter and receiver.

Continuing into box 606, the actions corresponding to this box are those taken during an active session that effects the active session, or, by the system to reconfigure the assignable channels for new sessions. Actions affecting a single session may include reassigning the session to a different channel (an inter-channel session handoff will be carried out), as the base station or other link detects that a session is underutilizing its existing channel, or is bottlenecked by its existing channel. Other actions include assigning a parallel channel to an already active channel, when a short or specific data transfer is needed. Exemplars include a device in an active low data rate voice channel requesting a specific piece of data transfer that requires a high data rate channel. Rather than allocating a high data rate channel to an otherwise low data rate session, a parallel session is set up and used just for the one specific data transfer event. Other examples include receiving a call while downloading music, getting SMS messages while talking, etc.

Actions affecting assignable channels include those taken when a carrier is assigned a different orthogonal code length L. A base station of other session provider that is not only an end-point device will monitor channel usage. Channel usage may include a recent history of requested channel types (requested data rates) and other channel usage information. When the device detects that there is a high demand for channels of certain types, it will quiesce a carrier having one of the low-demand channel types and then reassign it a new code length associated with the high demand channel types. This enables the system to actively use the available bandwidth (the frequency range of all of the carriers) in the most efficient manner possible.

Finally, box 608 is entered. The actions associated with box 608 are any needed to release resources at the end of the session. These actions may be simple or complex, depending on the device, but result in the channel being available for reassignment. In an end-point device such as a cell phone, this may be as simple as clearing a few state bits and waiting for a next session to start. In a base station or other non-end-node device, the actions will be more complex, but at the least include setting flags to indicate that a previously assigned resource is available for reassignment.

The inventive concepts described herein are at least partially manifest as executable code in the device in which the inventive concepts are manifest, including mobile devices, end-point nodes, or other nodes in a wireless network where a node may be a base station, a link, or any other non-end-point source or destination. The code can be located on any computer readable media, executable by a CPU found in any of the devices (end-point or non-end-point nodes). Nodes or devices all have some form of programmable instructions executable by a logic engine, usually computer readable memory and a CPU which can read the memory, as is well established in the wireless communications art. Due to their ubiquitous and well established nature, a CPU and its associated memory have not been separately illustrated, but are understood to be part of each device along with the software (firmware, programming codes, storable state indicators, etc.) needed to enable the inventive concepts disclosed herein.

A node in a network is any point in a network where processing of any type takes place, as compared to the signals in transmission (over a wired or an air interface). A device, including end-point devices (cell phones, PDAs, computers, etc.) and non-end-point devices (computers used as relay or link stations, etc.) are nodes. A node may also be a collection of individual compute devices, compute engines, servers, disk farms, and other components where each individual component that makes up the node may have its own CPU and memory. Taken together, they perform the function of a node. The individual servers, devices, or multiple CPUs used at a node may be loosely or tightly coupled; any configuration is contemplated herein. This would typically be the case in larger nodes, such as base stations or message control centers or any of the other larger stations that are part of a network.

From the above description of exemplary embodiments of the disclosed inventive concepts, it is manifest that various techniques can be used for implementing the concepts without departing from its scope. Moreover, while the invention has been described with specific reference to certain embodiments, a person of ordinary skill in the art who also has the benefit of the present disclosure would recognize that changes could be made in form and detail without departing from the spirit and the scope of the inventive concepts disclosed herein. For example, as technology improves the exemplar transmitter/receiver arrangements disclosed may be replaced while still staying well within the inventive concepts disclosed for the multi-rate channel generation and use disclosed herein. Thus, it is understood that the invention is not limited to the particular exemplary embodiments described herein, but is capable of many rearrangements, modifications, and substitutions without departing from the inventive scope.

What is claimed is:

1. A node configured to be operable in a wireless network comprising:
a transmitter configured to transmit multicarrier code division multiplexed OFDM data transmissions, further configured to encode a data signal containing symbols for transmission using an orthogonal code of length L, and configured such that if L=1 then the data signal is not logically changed, and further configured to transmit the data signal using a carrier's orthogonal subcarriers where the total number of subcarriers is M, L<=M, and the number of subcarriers used per symbol is dependent on L;
a receiver configured to receive multicarrier code division multiplexed OFDM data transmissions, further configured to process the carrier's orthogonal subcarriers in a manner based on L, and configured to decode a received data signal using the orthogonal code of length L where, if L=1, the data signal is not logically changed.

2. The node of claim 1 further configured to allow transmission and reception using a selected carrier from a set of N carriers, each of the N carriers having M orthogonal subcarriers.

3. The node of claim 2 where the N carriers are further configured such that at least one carrier is configured with L=1 and all the carriers' subcarriers are assignable to a single session.

4. The node of claim 2 where each of the N carriers is associated with an orthogonal code length which is less than or equal to M, and where each of the N carriers has a number of assignable communications channels equal to its associated orthogonal code length, and where each associated orthogonal code length becomes the value of L for the transmitter and the receiver when the channel is active.

5. The node of claim 4 where each of the N carriers is further configured to allow its associated orthogonal code length to be changed.

6. The node of claim 4 where associated orthogonal code lengths comprise at least two different lengths.

7. The node of claim 6 where one of the at least two different lengths is of length 1, the assignable channel associated with length 1 being an OFDM channel, with a same number of orthogonal subcarriers.

8. A method of using channels in a node, the node configurable for use in a wireless network, the method comprising:
using an orthogonal code length L on a symbol to be transmitted;
selecting a carrier usable to transmit the symbol, the carrier having M orthogonal subcarriers, where L is less than or equal to M, and where the number of subcarriers selected to transmit the symbol is equal to L.

9. The method of claim 8 further comprising:
initializing a session using the orthogonal code of length L and the selected carrier;
transmitting the symbol using the L subcarriers.

10. The method of claim 9 further comprising:
receiving a transmission;
using the orthogonal code of length L on the signal received over the L subcarriers.

11. The method of claim 9 further comprising:
detecting a need for a different data rate;
initializing a second session based on the different data rate using a different orthogonal code length L1 and a different carrier, L1 being less than or equal to the number of subcarriers in the different carrier.

12. A method of using multiple channel types in a wireless system, the method comprising:
detecting a session initialization request;
determining a type of channel to associate with the request;
using the determined channel type to select an orthogonal code of length L;
selecting a carrier based on L where the carrier has a number of orthogonal subcarriers equal to or greater than L;
enabling a session to be initialized using a communications channel comprising using the determined L and the associated carrier.

13. The method of claim 12 where the type of channel is characterized by one of: voice, http, ftp, streaming video, or, streaming audio.

14. The method of claim 12 further comprising:
using a default data rate to make a selection of an orthogonal code of length L when a type of channel cannot be determined.

15. The method of claim 12 further comprising:
transmitting a symbol that has been spread using the orthogonal code.

16. The method of claim 15 further comprising:
transmitting the symbol further using L of the orthogonal subcarriers.

17. The method of claim 16 further comprising:
receiving the symbol;
reassembling the spread symbol from the L orthogonal subcarriers;
using the orthogonal code to recover the symbol.

18. The method of claim 14 further comprising:
detecting that the enabled communications channel has a data rate not optimized for the session;
selecting a different L and an associated carrier based on a more optimized data rate;
continuing the session using a different communications channel based on the different L and an associated carrier.

19. The method of claim 12 where the multiple channel types further comprise a set of N carriers each having M orthogonal subcarriers, where the set of selectable orthogonal code lengths all have lengths less than or equal to M, and where each of the N carriers presently has an associated orthogonal code length.

20. The method of claim 19 further comprising:
detecting at least one carrier that is not optimized for the data rates of sessions being one of generated or requested;
quiescing the non-optimized carrier, if it is not already quiesced;
associating a different orthogonal code length with the quiesced carrier, the different length based on sessions being one of generated or requested, resulting in a reconfigured carrier;
enabling a session using the reconfigured carrier.
